(19) United States
(12) Patent Application Publication
(10) Pub. No.: US 2006/0203511 A1
(43) Pub. Date: Sep. 14, 2006

(54) Incident assembly of light guide plate

(75) Inventor: Wen-Pao Tseng, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/074,630

(22) Filed: Mar. 9, 2005

(51) Int. Cl. G11B 7/135

(52) U.S. Cl. 362/608; 362/621

(57) ABSTRACT

A light guide plate includes an incident plane for receiving a light source of a light emitting device, a bottom surface connected to the incident plane, and an emergent plane corresponding to the bottom surface for outputting the light source of the light emitting device, and the light emitting device is installed on one side of the incident plane of the light guide plate; wherein the incident plane of the light guide plate has a structure consisted of a plurality of polyhedrons, such that an incident light of the light emitting device passes through the polyhedron structure to improve the light diffusion effect and make the light produced by the light emitting device evenly diffused towards the emergent plane of the light guide plate.

### BACKGROUND OF THE INVENTION

1. Field of the Invention

The present invention relates to an improved incident assembly of a light guide plate that can effectively improve the diffusion at an incident plane.

2. Description of the Related Art

Referring to FIG. 1, the schematic view of a basic architecture and a conventional light source projecting assembly of a general liquid crystal module are shown. The liquid crystal module usually comes with a light emitting device (which is a light emitting diode (LED) 10 in this example as illustrated in FIG. 1), a light guide plate 20, a diffuser 30, a prism 40, and a liquid crystal display panel 50; wherein the diffuser 30 and the prism 40 are arranged in order and disposed above the light guide plate 20, and the light guide plate 20 is made of a polyester material and substantially wedge-shaped. The light guide plate 20 includes an incident plane 21, an emergent plane 22, and a bottom surface 23 having a predetermined angle with respect to the emergent plane 22. The light emitting device 10 is installed at one side of the incident plane 21 of the light guide plate 20. The light source of the light emitting diode 10 is received by the incident plane 21 and passed through the bottom surface 23 and out from the emergent plane 22. The light source will be projected onto the liquid crystal display panel 50 after passing through the diffuser 30 and prism 40.

Since the main function of the diffuser 30 is to diffuse a passing light evenly, it has an insignificant effect of improving the Mach band phenomenon of the liquid crystal module. Therefore, some backlight modules painstakingly elongate the gap between the light guide plate 20 and the diffuser 30 to extend the range of the light being diffused from the light guide plate 20 into the diffuser 30, so as to reduce the dark band zone. However, such structural design not only has very little effect, but also increases the thickness of the backlight module, which is totally against the original intention of the light and thin design of the liquid crystal module. Summary of the Invention

It is a primary objective of the present invention to provide an improved light incident assembly of a light guide plate, such that the light produced by a light emitting device of a liquid crystal display (LCD) can be projected evenly onto an LCD panel, and the light guide plate of the LCD comprises an incident plane for receiving the light of the light emitting device, a bottom surface coupled with the incident plane, and an emergent plane corresponding to the bottom surface for outputting the light of the light emitting device. The light emitting device is installed on a side of the incident plane of the light guide plate, and the light emitting device also shows its light effect by means of a light guide plate, an optical film and an LCD panel. The incident plane of the light guide plate has a plurality of polyhedron structures, and the polyhedron structures can improve the light diffusion effect of an incident light source of the light emitting device to produce an even light.

### BRIEF DESCRIPTION OF THE DRAWINGS

FIG. 1 is a schematic view of a light projection assembly of a conventional liquid crystal module;

FIG. 2 is a perspective view of the structure of a light guide plate according to a first preferred embodiment of the present invention;

FIG. 3 is a perspective view of the structure of a light guide plate according to a second preferred embodiment of the present invention;

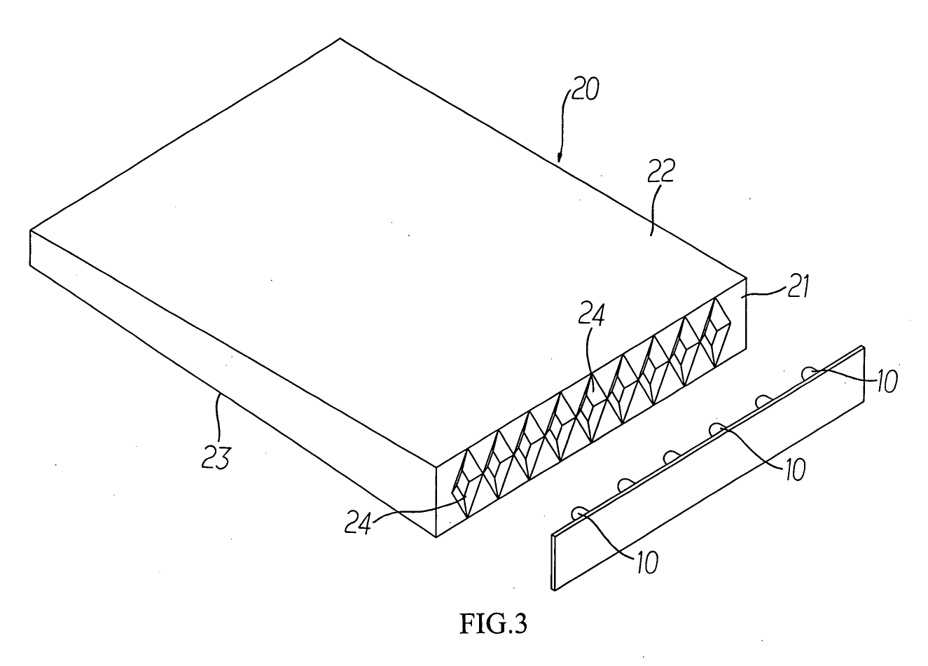

FIG. 4 is a perspective view of the structure of a light guide plate according to a third preferred embodiment of the present invention;

FIG. 5 is a perspective view of the structure of a light guide plate according to a fourth preferred embodiment of the present invention; and

FIG. 6 is a perspective view of the structure of a light guide plate according to a fifth preferred embodiment of the present invention.

### DETAILED DESCRIPTION OF THE PREFERRED EMBODIMENTS

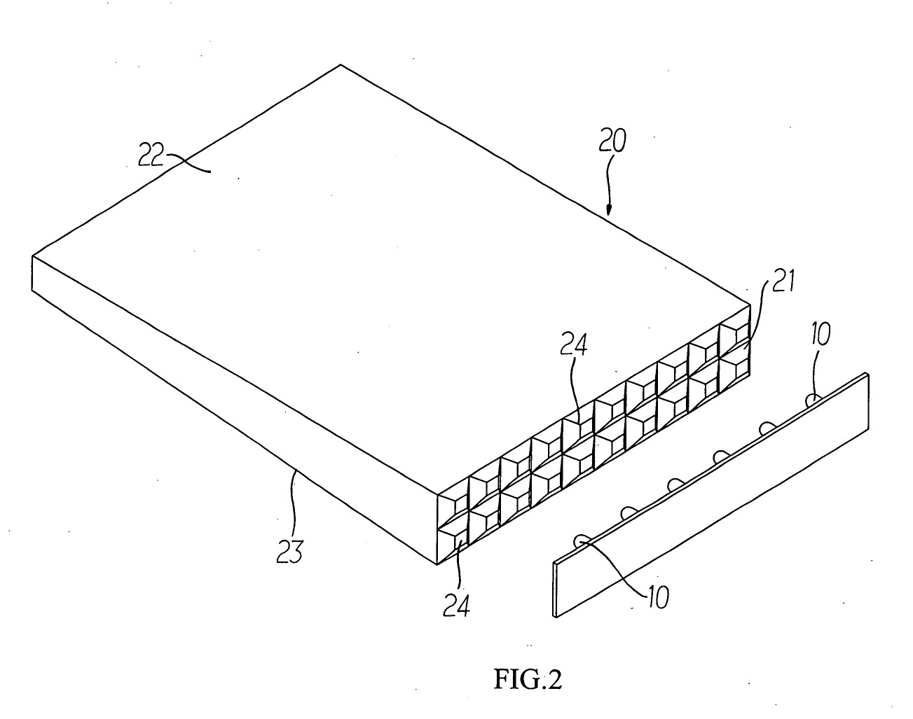

Referring to FIG. 2, an improved incident assembly of light guide plate in accordance with the present invention is illustrated. The invention comprises a plurality of polyhedral structures disposed on an incident plane of a light guide plate, and the polyhedral structures produce a diffusion effect on a light source of a light emitting device, such that the light source of each light emitting device can be emitted evenly to provide a better display effect for a liquid crystal display.

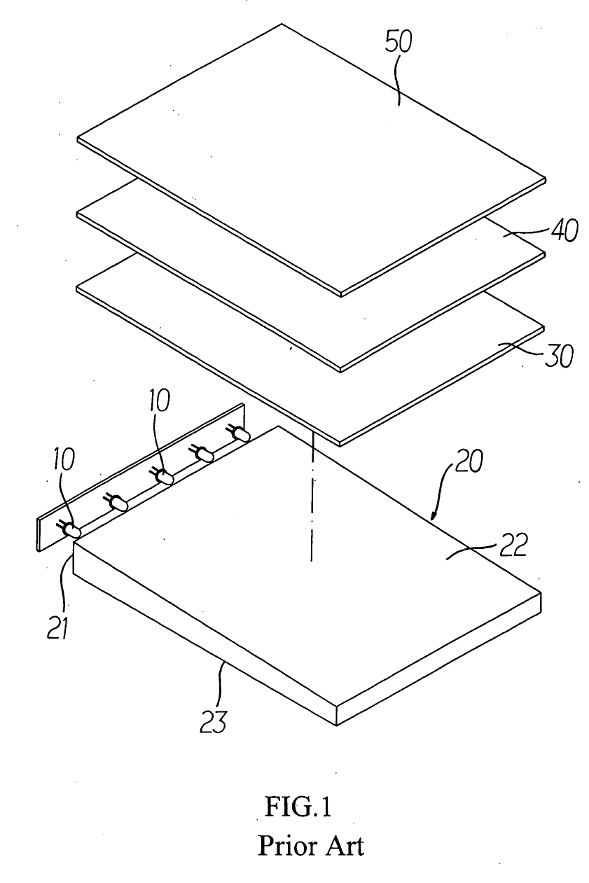

In actual practices, a backlight module has the same structure as shown in FIG. 1, and the light emitting device (which is a light emitting diode (LED) 10 in this example as illustrated in FIG. 1), a light guide plate 20, a diffuser 30, a prism 40, and a liquid crystal display (LCD) panel 50; wherein the diffuser 30 and the prism 40 are arranged in order and above the light guide plate 20, and the light guide plate 20 is made of a polyester material. The light guide plate 20 comprises an incident plane 21, a bottom surface 23 coupled to the incident plane 21, and an emergent plane 22 corresponding to the bottom surface 23 for outputting the light source of the light emitting diode 10, and the light emitting device 10 is installed on one side of the incident plane 21 of the light guide plate 20.

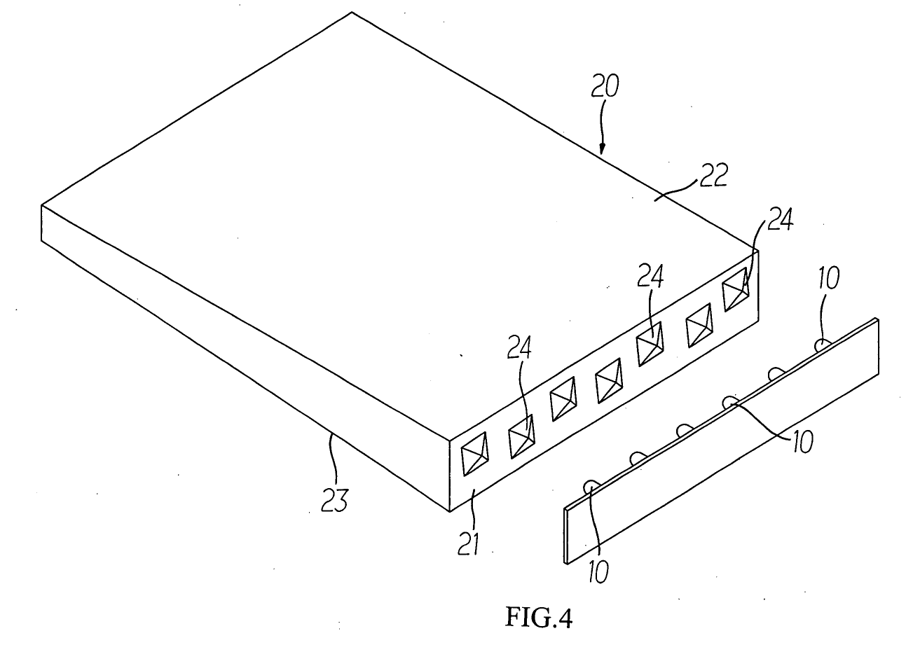

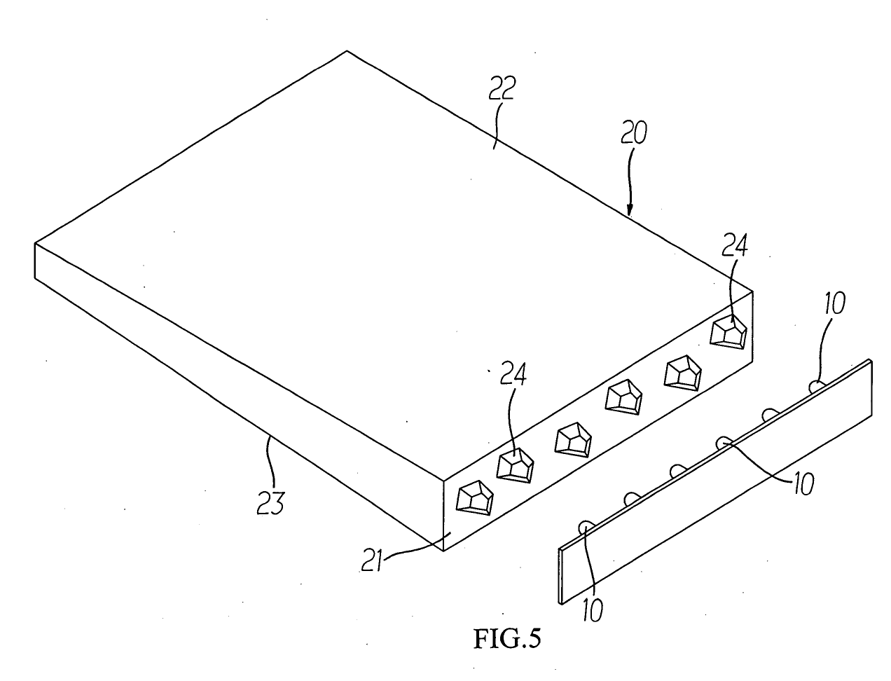

The major technical characteristics of the present invention reside on that the incident plane 21 of the light guide plate 20 has a plurality of polyhedral structures 24, and the polyhedral structures 24 can be arranged in a continuous, orderly and even fashion, and a conical section of the polyhedral structure 24 is protruded from the emergent plane 22 as shown in FIG. 2 or embedded into the incident plane 21 as shown in FIG. 2. Of course, each of the polyhedral structures 24 can be arranged not in a continuous, orderly and even fashion as shown in FIGS. 4 and 5, such that the light source emitted from one side of the light emitting diode 10 is received by the incident plane 21 of the light guide plate 20, and the polyhedral structures 24 adds a diffusion plane to produce a diffusion, and then the light source can be emitted evenly after the light is reflected from the bottom surface 23. The light source is guided out from the emergent plane 22 to the diffuser 30 and prism 40, and then projected onto the LCD panel 50.

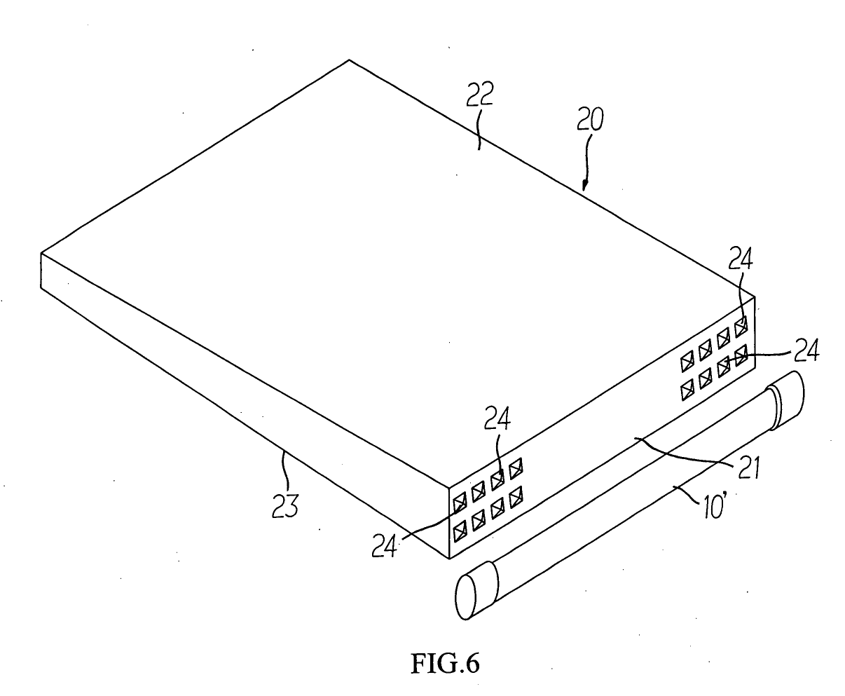

Further, the light emitting device could be the device used in the preferred embodiment as shown in FIG. 6, which is comprised of a lamp 10′, and the light on both sides of the lamp 10′ is weaker, therefore the incident plane 21 of the light guide plate 20 has a plurality of polyhedral structures 24 disposed at the corresponding positions proximate to both sides of the lamp 10′. The polyhedral structures 24 add a diffusion plane to produce a diffusion effect, which gives an even emergent light of the light source.

In summation of the above description, the present invention herein provides an improved incident assembly of a light guide plate and complies with the patent application requirements. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved incident assembly of light guide plate, of which said light guide plate having an incident plane for receiving a light source of a light emitting device, a bottom surface coupled to said incident plane, and an emergent plane corresponding to said bottom surface for outputting said light source of said light emitting device, and said light emitting device is installed on one side of said incident plane of said light guide plate; characterized in that said incident plane of said light guide plate comprises a plurality of polyhedral structures.

2. The improved incident assembly of light guide plate of claim 1, wherein said plurality of polyhedral structures can be arranged in a continuous, orderly and even fashion.

3. The improved incident assembly of light guide plate of claim 1, wherein said plurality of polyhedral structures can be arranged not in a continuous, orderly and even fashion.

4. The improved incident assembly of light guide plate of claim 1, wherein said each polyhedral structure has a conical section protruded from said incident plane.

5. The improved incident assembly of light guide plate of claim 1, wherein said each polyhedral structure has a conical section embedded into said emergent plane.

6. The improved incident assembly of light guide plate of claim 1, wherein said light emitting device is a lamp, and said incident plane of said light guide plate comprises a plurality of polyhedral structures disposed proximate to both sides of said lamp.
